(19) United States
(12) Patent Application Publication
(10) Pub. No.: US 2022/0404244 A1
(43) Pub. Date: Dec. 22, 2022

(54) METHOD AND APPARATUS FOR DRYING BIOLOGICAL SAMPLES

(71) Applicant: Daniel Oldman Attoh, Temple, PA (US)

(72) Inventor: Daniel Oldman Attoh, Temple, PA (US)

(21) Appl. No.: 17/843,844

(22) Filed: Jun. 17, 2022

Related U.S. Application Data
(60) Provisional application No. 63/212,606, filed on Jun. 19, 2021.

(51) Int. Cl. G01N 1/30; G01N 1/31; G01N 1/44

(52) U.S. Cl. CPC G01N 1/30; G01N 1/312; G01N 1/44

(57) ABSTRACT

This disclosure pertains to methods and apparatus for drying bio-specimens.

### RELATED APPLICATIONS

This application claims priority to U.S. Provisional Patent Application No. 63/212,606, filed Jun. 19, 2021, and which is incorporated herein fully by reference.

### FIELD OF THE INVENTION

This disclosure pertains to the drying of biological samples, and, particularly, to the drying of biological samples that need to be analyzed quickly and accurately.

### BACKGROUND

In the medical field, it often is necessary to rapidly analyze a bio-specimen. This is commonly referred to as Rapid Onsite Evaluation or ROSE. The bio-specimen may comprise blood, tissue, urine, other bodily fluids, etc. For instance, during a surgery, while the patient is open, it is common to take a biological specimen from the patient's body, e.g., blood or tissue, to test it for a particular property, component, contaminant, etc. Accordingly, in such surgical environments, time is of the essence in analyzing the specimen insofar as it is almost always desirable to minimize the duration during which the patient is open.

Commonly, a sample of the specimen is placed on a substrate, such as a glass slide, prior to analysis. Also, commonly, the sample must be dried before it can be analyzed. Often, it is necessary to test or analyze a number of samples in succession, often with the need to wait for the results of the analysis of the preceding sample before testing or analyzing the next sample. For instance, in fine needle aspiration (FNA) during a surgery, it is common to have to test at least 3 to as many as 10 or 12 blood samples in succession before the results are considered reliable. Thus, 3 to 12 samples would need to be dried before testing.

Presently, there are many ways that such samples are dried. One common technique is to rapidly wave the slide with the sample on it manually through the air to hasten its drying. In other case, a hair dryer or fan is used to blow warm or cool air over the bio-sample to hasten its drying time. These techniques, however, are inefficient in that they do not reduce the time to dry a sample by much. Commonly, it may take about 90 seconds to sufficiently dry a sample by waving it around manually. Using a blow dryer may dry a sample in slightly less time. Furthermore, waving a sample around in the air and/or blowing air over a sample is likely to cause some of the sample to become aerosolized and/or otherwise become airborne, which is extremely undesirable since the sample may contain germs or other constituents that may be dangerous to the persons in the room, including the patient.

Even further, when a sample is being waved around manually or being exposed to rapid air flow, it can easily be mishandled such that it becomes contaminated or even ends up on the floor or smashed against a wall.

In addition, all of these drying techniques require the attention of staff, e.g., a cytotechnologist, to perform the drying technique for a significant portion of the drying time, if not the entire drying period, which time might be better applied to other tasks.

In yet other techniques, bio-samples are dried by placing them on top of a hot plate. However, again, this only reduces the drying time by a small percentage.

A typical blood sample may require between 70 and 90 seconds to dry sufficiently using the aforementioned techniques before it is ready for analysis. Depending on the procedure, a radiologist or pulmonologist may take from five minutes to an hour to obtain one specimen. Thus, for a thyroid FNA, for example, it may require an average of 5 minutes to obtain one specimen (sometimes referred to as a “pass”). Assuming for example that it takes five minutes to obtain one specimen, drying time takes about 90 seconds, and prepping and staining takes about two minutes before it is ready to be looked at or screened under the microscope, the total time for each pass commonly is about five to ten minutes. If five or ten passes are performed, it would require about 25 minutes to an hour for the entire procedure. If the time to dry a slide could be reduced from about 90 seconds to about 20 seconds, it could save ten or more minutes for such a procedure.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1 is a perspective view of an apparatus for rapidly drying biological specimens in accordance with an embodiment;

FIG. 2 is a closer view of the chamber of the apparatus of FIG. 1 in accordance with an embodiment, but with the bottom tray removed to provide a clearer view into the chamber;

FIG. 3 is another perspective view of the apparatus of FIG. 1 with the front door open and the specimen tray in an open position in accordance with an embodiment;

FIG. 4 is a perspective view of the apparatus of FIG. 1 with the front door closed and the specimen tray in the closed position in accordance with an embodiment;

FIG. 5A is a circuit diagram of a first portion of the circuitry of the device of FIG. 1 in accordance with an embodiment;

FIG. 5B is a circuit diagram of a second portion of the circuitry of the device of FIG. 1 in accordance with an embodiment;

FIG. 6A is a front plan view of another apparatus for rapidly drying biological specimens in accordance with a second embodiment in which the apparatus comprises two separable parts;

FIG. 6B is a perspective view of the apparatus of FIG. 6A in accordance with an embodiment; and

FIG. 6C is another perspective view of the apparatus of FIG. 6A in accordance with an embodiment showing two different perspective views of the bottom part of the apparatus.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed or otherwise provided explicitly, implicitly, and/or inherently (collectively “provided”) herein.

In accordance with an embodiment, an apparatus for drying biological specimens comprises an enclosed chamber in which the specimen is dried by the application of heat, rapid air flow, and/or ultraviolet light in an enclosed space so that the specimen is both safe from . The ultraviolet light serves the additional function of being germicidal and thereby further reducing or eliminating the danger of airborne or aerosolized specimen.

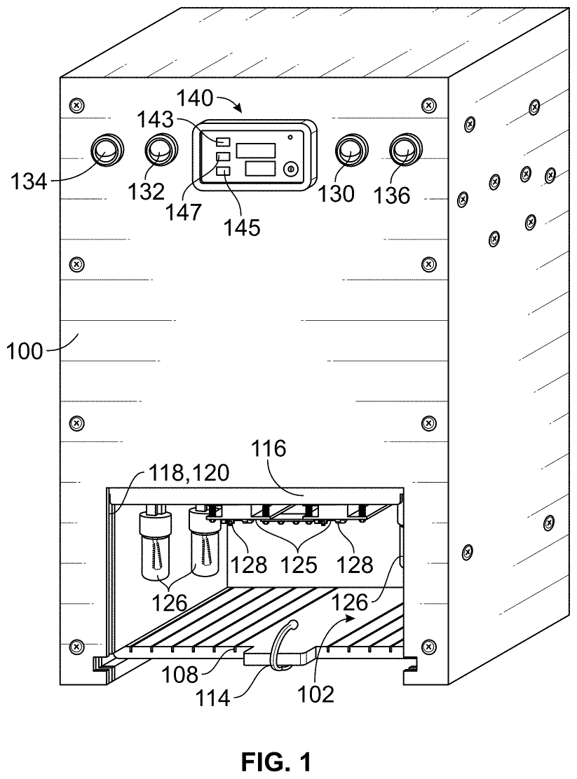

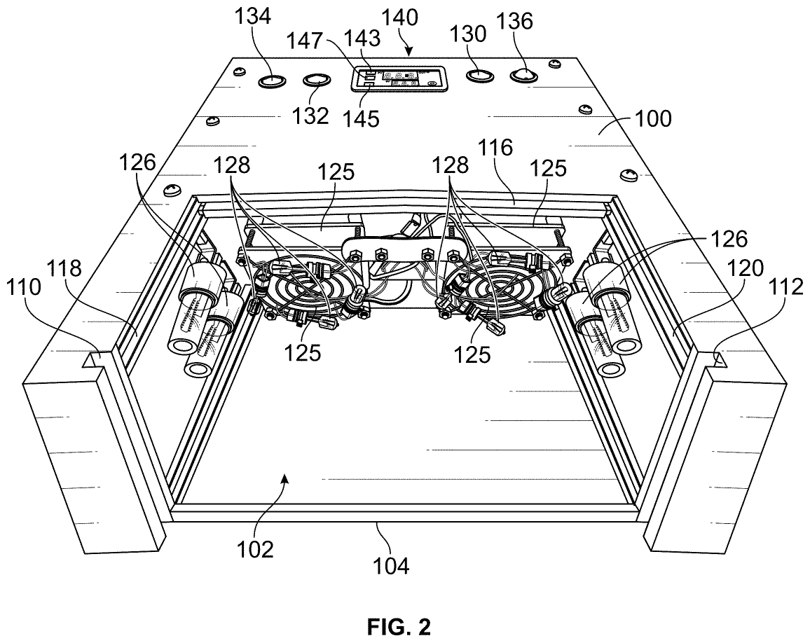

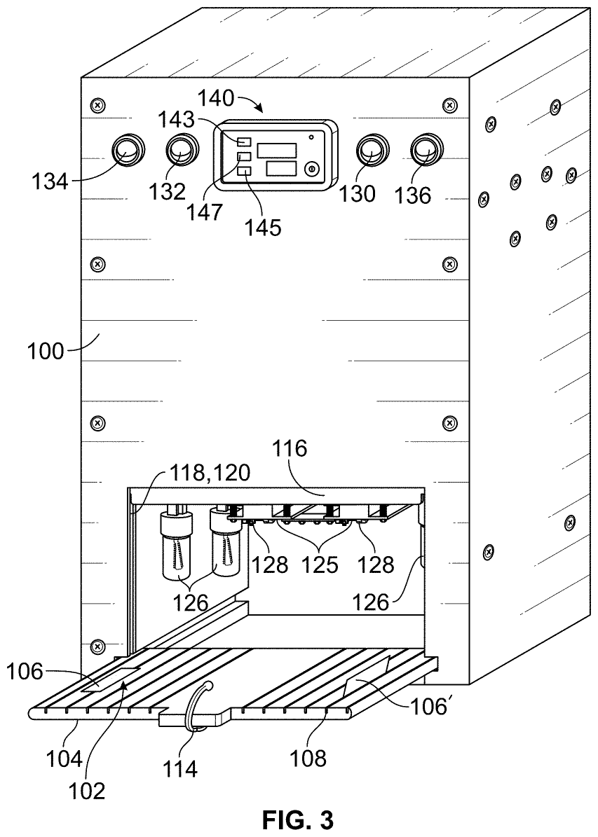

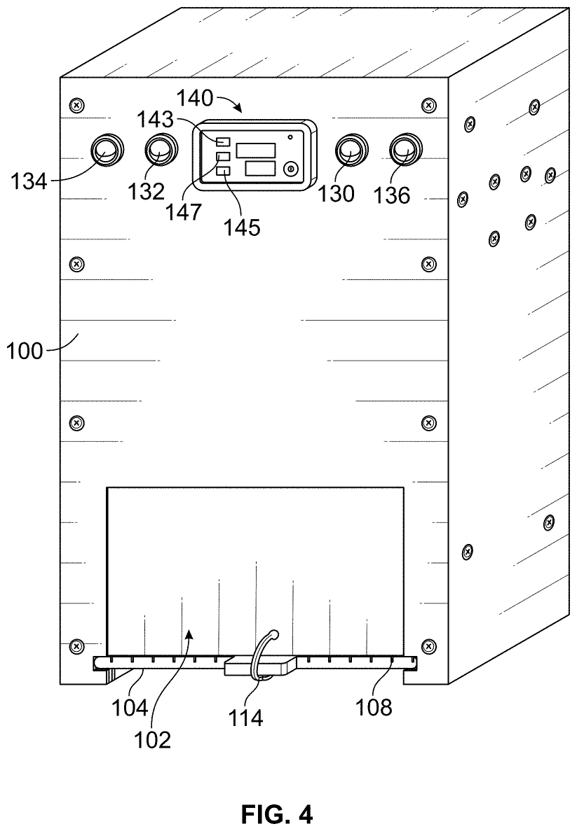

FIG. 1 is a perspective view of a biological specimen drying apparatus according to one embodiment with the chamber door open and the bottom tray in the closed position. FIG. 2 is a closer view of the chamber portion of the apparatus of FIG. 1, but with the bottom tray removed to provide a clearer view into the chamber. FIG. 3 shows a perspective view of the apparatus from a different viewpoint and with the bottom tray in an open position. FIG. 4 is another perspective view of the apparatus from the same viewpoint as FIG. 3, but with the door closed and the bottom tray in the closed position. The apparatus comprises a housing 100 for containing the specimen chamber 102 into which the biological specimens will be placed for drying. In use, a specimen, such as a slide containing a blood droplet may be placed on the tray 104 that forms the bottom of the chamber 102 and housing 100. The slide may be placed flat on the tray 104, as shown at 106 in FIG. 3, or may be placed into one of the slots 108 on the top surface of the tray 104 to stand generally upright, such as shown at 106′ in FIG. 3.

In an embodiment, the tray is slidable in a horizontal direction within grooves 110 and 112 in the housing so that the tray may be slid out of the chamber to a position such as shown in FIG. 3 in order to ease the placement of the specimen on the tray without it contacting other surfaces or portions of the apparatus, which contact could adversely affect the specimen. In embodiments, a handle 114 may be provided to assist with the sliding of the tray 104. In other embodiments, the tray may be motorized so that it may be transitioned between the open position (as shown in FIG. 3) and the closed position (as shown in FIGS. 1 and 4) at the press of a button (not shown).

Furthermore a vertical door 116 is positioned in grooves 118, 120 on the housing that can be slid between an up or open position, such as shown in FIGS. 1 and 3, and a down position, such as shown in FIG. 4. The door 116 may be manually operable or may be motorized so that it may be transitioned between the open position (as shown in FIG. 3) and the closed position (as shown in FIG. 4) at the press of a button (not shown).

The upper portion of the housing 100 may contain all of the necessary circuitry, including microchips, circuit boards, batteries, power supplies, displays, switches, button hardware, other user interface components, etc. In embodiments, the apparatus may be adapted to run alternately on either standard alternating current, such as 120 Volt, 60 Hz alternating current (in the US) or 240 volt 50 Hz (in many other countries), or a self-contained battery, such as a rechargeable battery within the housing. In embodiments, the surface of the housing may be further equipped with one or more USB ports coupled to the battery and configured for charging the battery. In addition, the housing includes a port for plugging the apparatus into an external power source, such as 120 volt, 60 Hz or 240 volt, 50 Hz wall power via a standard plug.

Referring to FIG. 2, which is a close up view of the chamber 102, the chamber includes two fans 125 for forcing air over the specimen in order to dry the specimen. The number of fans and their specific placement may vary. Additionally, at least one ultraviolet (UV) light 126 is located in the chamber to providing germicidal light within the chamber in order help sterilize the chamber during drying operations. In the embodiment shown in the FIGS., there are four such UV lights 126, including two each positioned on opposite sides of the chamber.

The fans may be configured to push air in either direction. However, in a preferred embodiment, the fans push air toward the specimen, i.e., downward in FIGS. 1 and 2. An opening (not shown) may be provided in the lower portion of the housing (or in the door) to allow the forced air to flow out of the chamber more easily. In an embodiment, the opening may be equipped with a filter, such as a HEPA filter, to reduce or eliminate the possibility of aerosolized specimen becoming airborne in the room.

In addition, the chamber is heated by eight halogen light bulbs 128, located four each surrounding the air outlet of each of the two fans 125. In other embodiments, the heat may be provided by heaters either in the fans or separate from the fans in the chamber, rather than light bulbs.

The size of the housing and the chamber portion of the housing can vary depending on the size of the specimens that the apparatus will be used to dry. The greater the size of the chamber, the greater the variety (and size) of specimen that can be processed in the apparatus. Thus, the apparatus can be made quite small if it is intended to be used to dry only small specimens, such as a single slide at a time. On the other hand, if the apparatus will be used to dry many slides simultaneously or specimens of greater volume/size, the chamber may be sized to accommodate such specimens. In one embodiment, adapted to dry a single slide per drying session, the overall device may be approximately 6 inches wide by 3 inches in depth by 7 inches in height, wherein the chamber portion of the housing is approximately 6 inches wide by 3 inches deep by 5 inches in height. The inner dimensions of the chamber would be slightly smaller in width and depth (due to the width of the walls of the housing having some thickness).

As noted above, the apparatus may be any size or shape, but preferably larger versions are less than 3 feet wide by 2 feet deep by 4 feet in height so that they can be mounted on or placed atop a wheeled cart in order to remain easily portable.

Additionally, the size of the specimens that are to be processed at any given time may also dictate (at least partially), the appropriate size, number, power, placement, etc. of the fans, heating elements, and/or germicidal elements.

In embodiments, the apparatus may further include sensors, electronics and user interface mechanisms to allow a user thereof to control and/or set any one or more of the temperature in the chamber, the air flow velocity, the amount of germicidal light, and the duration of the drying operation. Such sensors may include temperature sensors and air pressure sensors. Thus, the user can set any one or more of those parameters and then turn his or her attention to other tasks with the knowledge that the time, temperature, etc. of the drying operation is being controlled automatically and does not require his or her constant attention.

In embodiments, any or all of the germicide, heat, or airflow may be turned off insofar as certain types of specimens may be adversely affected by any of those environmental factors.

In one embodiment adapted for drying blood specimens for FNA, the air speed is set between 20 and 40 psi, and the temperature is set between 70 and 80 degrees Fahrenheit.

In one embodiment as illustrated in the FIGS., the device includes two buttons 130, 136 for turning the heat on or off (the first button 130 coupled to control a first four of the heating lights and the second button 136 couple to control the other four of the heating lights), another button 132 for turning the fan(s) on or off (a single button 132 controls both fans), and another button 134 for turning the UV light(s) on or off (a single button controls all the UV lights).

In more complex embodiments, each of the temperature, UV light, and air flow may be more precisely controlled and/or set by a user via more robust controls that allow the user to set an exact temperature, air flow, and/or UV light level.

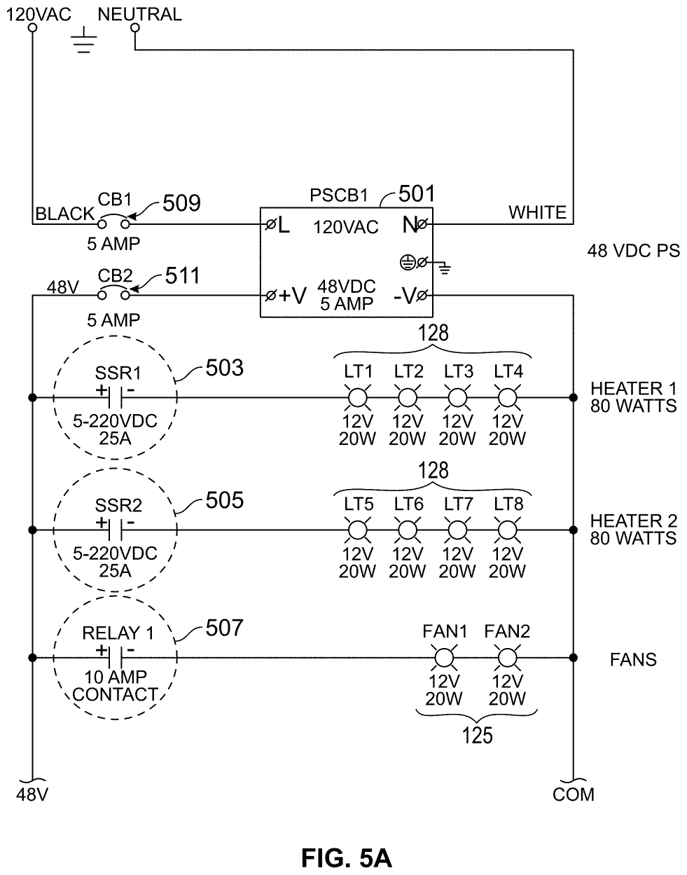

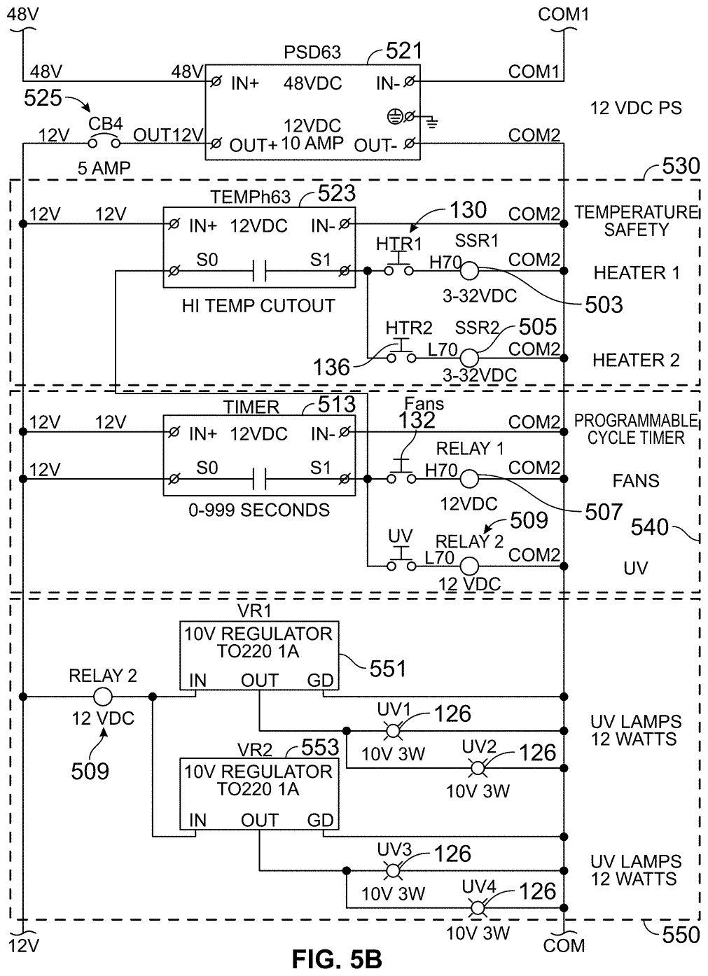

Further electronics are provided to allow a user to set a specific time duration for a drying operation. Merely as one simple example as shown in the FIGS., a time controller apparatus 140 includes interface buttons for setting the duration of a drying operation. In this exemplary embodiment, the interface includes an LED display for showing the drying time, an up button 143 for increasing the drying time, a down button 145 for decreasing the drying time, a set button 147 for setting the drying time to the displayed time, and a reset button 148. Those various buttons operate circuitry (discussed in more detail below in connection with FIG. 5) that set a timer circuit that is coupled to the other operational elements of the apparatus (e.g., the UV lights, heating lights, and fans) to turn them on at the start of a drying cycle and off at the designated time as set by the user at the end of the cycle. In a preferred embodiment, the apparatus may be configured to issue a visual and/or audible indication of when a drying cycle has ended.

During setting of the drying time, the LED display may show the duration (e.g., in seconds) that the timer is currently set to (as selected by the user using the up and down buttons). Then, when a drying cycle is currently active, the display may show the time remaining in the drying cycle, the current duration of the drying cycle so far, or both.

In an embodiment, an additional light (not shown) may be mounted on the outside of the housing to provide light to help a user of the device see his or her surroundings. Particularly, operating rooms are often dimly lit outside of the surgical field. The operator of the apparatus (or other individuals) may need additional light in a confined area near the apparatus in order to write down information concerning the specimen and/or to prepare the specimens. A switch for turning the light on or off (not shown) also may be provided on the housing adjacent the external light.

In tests in which the air pressure is set to 20-40 psi and the temperature is set to 70-80 degrees Fahrenheit, it is found that the apparatus can reduce the time to dry a single slide by almost 80%, i.e., from about 90 seconds to about 20 seconds.

FIGS. 5A and 5B comprises a circuit diagram of the electronics of the apparatus in accordance with one exemplary embodiment. FIG. 5A shows the 48 volt portion of the circuitry and FIG. 5B shows the 12 volt portion of the circuitry.

Referring first to FIG. 5A, a power supply module 501 receives 120 volt 60 HZ AC or 240 volt 50 Hz current and converts it to 48 volts DC. The power-in and power-out sides of power supply module 501 each include a 5 amp circuit breaker 509, 511. The 48 volt DC output is coupled in parallel to provide power to (1) a first four of the heating lights 128, (2) a second four of the heating lights 228, and (3) the two fans 125, respectively, through the secondary-sides (load sides) of three relays, 503, 505, 507, respectively. Note that the UV/germicidal lights run on 12 volt DC power, and thus, do not appear in FIG. 5A.

Referring now to FIG. 5B, another power module 521 receives the 48 volt DC power output of the 48 volt power supply 501 and converts it to 12 volt DC power. The 12 volt DC power is coupled, through another 5 amp circuit breaker 525, to three parallel circuit legs, labelled 530, 540, and 550, respectively, in FIG. 5B.

The first leg 530 comprises a high-temperature cutout circuit 523 that includes a temperature sensor located in the chamber for sensing the temperature in the chamber and logic for cutting off power to its control output terminal, S1, if the temperature exceeds a preset threshold. The output control terminal, S1, of the temperature cutoff circuit 523 is coupled in parallel through the two heater manual switch(es) 130, 136 and through the primary (control) side terminals of the relays 503, 505 to ground. Accordingly, the heaters can be turned on or off by either the manual switches 130, 136 or the temperature cutoff circuit 523. Note that, as can be seen in the diagram, the manual switches 130, 136 individually each control half of the heater lights, whereas the temperature cutoff circuit 523 controls all eight heater lights collectively.

The second leg 540 actually comprises two parallel offshoots from the 12 volt supply line, both coupled to a timer circuit 513. Timer circuit 513 may be an off the shelf unit or a purpose-built microchip/device. The timer circuit 513 shown in FIG. 5B represents the back-end (or functional) portion of the time controller apparatus 140 seen in FIGS. 1-4 for enabling a user to set the drying time. The first of the two parallel offshoots provides power to the timer circuitry 513. The second offshoot is coupled to the input control terminal, S0, of timer 513. As can be seen in FIG. 5B, the corresponding control output terminal, S1, of timer 513 is coupled in parallel to three circuit legs, namely, (1) to ground through the fan manual switch 132 and the primary (control) side input terminal of the aforementioned fan relay 507, (2) to ground through the UV manual switch 134 and the primary (control) side input terminal of another relay 509 that control the UV lights (as will be discussed further in connection with the third leg 550 of the 12 volt circuit), and (3) to the input control terminal, S0, of the temperature cutoff circuit 523 (and, thereby, to ground through the heater manual switches 130, 136 and heater relays as mentioned above in connection with the first leg 530). Thus, the timer 513 turns the power on to each of the two fans, the four UV/germicidal lights, and the eight heating lights when the timer starts and then off when the timer times out.

Finally, the third leg 550 circuity provides the power to the UV/germicidal lights 126. The 12 volt power is supplied through the secondary (load) terminals of the UV light relay 509 to the input terminal of two parallel 10 volt regulators 551, 553. The output terminals of the two voltage regulators 551, 553 are each coupled in parallel to provide power to two of the four UV lights 126.

FIGS. 5A and 5B show merely one exemplary embodiment of circuitry for the apparatus. Portions of the circuitry may be implemented by microchips, ASICs, logic circuits, processors, software running on processors, FPGAs, etc.

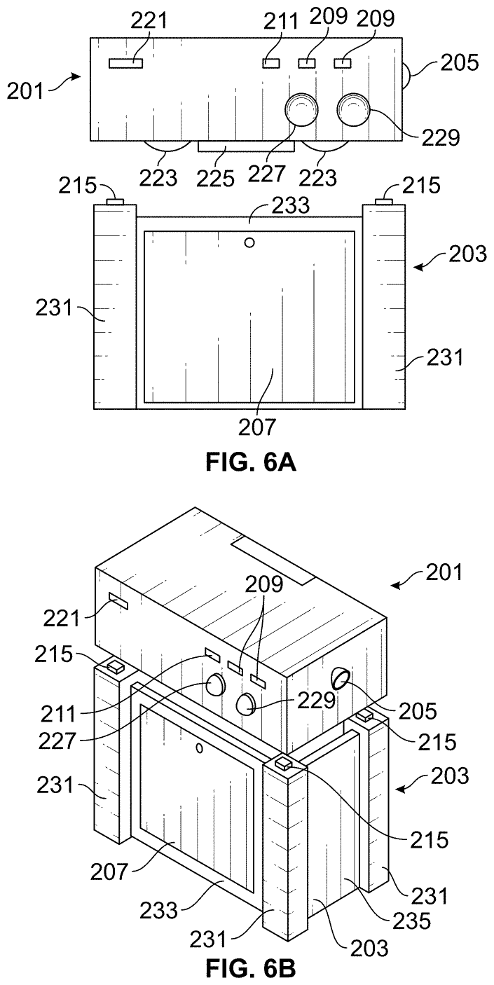

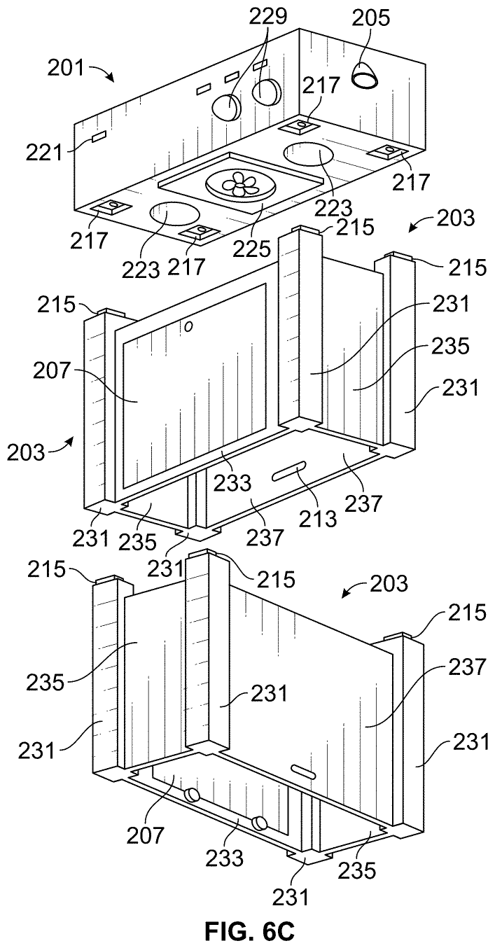

FIGS. 6A, 6B, and 6C show a second embodiment of an apparatus in accordance with the principles set forth herein. This embodiment is adapted to dry one or two slides at a time and comprises a top portion 201 that houses all of the circuitry and electrical apparatus of the device and a detachable bottom portion 203 forming the chamber for accepting the specimens. FIG. 6A is a front plan view of the apparatus shown with the two parts separated from each other, FIG. 6B is a top perspective view of the apparatus shown with the two parts separated from each other, and FIG. 6C is a bottom perspective view of the apparatus shown with the two parts 201, 203 separated, and including both a front bottom perspective view of the bottom portion 203 of the apparatus and a back bottom perspective view of the bottom portion 203 of the apparatus.

The top housing 201 is 6 inches wide by 3 inches deep by 2 inches in height. The bottom portion 203 is 6 inches wide by 3 inches deep by 5 inches in height and forms a chamber that is 5.98 inches wide by 2.98 inches by 4.98 inches (i.e., the walls are approximately 0.1 inches in thickness.

The bottom portion 203 comprises four legs 231 at the corners, two lateral side panels 235 connecting each pair of front and back legs, a front panel 233 connecting the two front legs and including a hinged door 207, and a back panel 237 connecting the two rear legs. The back panel incudes an opening 213 in which a filter is fitted for allowing filtered air to escape from the chamber during drying operations (as previously described). The top of each leg includes a tenon 215 that fits within a mortise 217 at each corner of the top portion 203 of the apparatus, and by which the bottom portion 203 may be securely assembled to the top portion 201. The apparatus does not have a bottom panel, but rather is intended to sit on a table top or cart top, which will provide the bottom surface upon which the slide or specimen will be placed.

The top portion 201 further includes a power button 221 for turning the apparatus on or off, a light button 227 for allowing a user to selectively enable or disable the light/heat sources 223, and a fan button 229 for allowing a user to selectively enable or disable the fan 225. Two standard USB ports 209 and one micro USB port 211 are provided on the front panel of the top portion 201. A miniature light 205 is provided on one side of the top portion 201.

The top portion includes two lights 223 for heating the air in the chamber and/or providing germicidal light within the chamber. It further includes a fan for forcing air over a specimen positioned in the chamber.

It will be understood that the top portion also houses within it, but not seen in the provided views, all of the electronics and circuitry for controlling the fan, lights, buttons, a battery, and/or a power supply.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. An apparatus for drying biological specimens comprising:
a chamber for receiving a biological specimen;
a heating element located in the chamber for heating the chamber;
a fan for forcing air through the chamber; and
a germicidal light source in the chamber.

2. The apparatus of claim 1 further comprising a panel forming the bottom of the chamber, wherein the panel is horizontally slidable between a first position in which it forms a bottom of the enclosed chamber and a second position in which it is substantially outside of the chamber.

3. The apparatus of claim 2 further comprising a vertical door operable between an open position, in which the chamber is exposed and a closed position in which the chamber is closed, the chamber being enclosed by at least the slidable bottom panel and the door.

4. The apparatus of claim 1 wherein the heating element comprises at least one light bulb located within the chamber.

5. The apparatus of claim 1 wherein the germicidal light comprises at least one ultraviolet light located within the chamber.

6. The apparatus of claim 1 wherein the fan is configured to provide an air pressure in the chamber between 20 pounds per square inch (psi) and 40 psi and the heating element is configured to maintain an internal temperature in the chamber of between 70 degrees Fahrenheit and 80 degrees Fahrenheit.

7. The apparatus of claim 1 further comprising a timer circuit configured to permit an operator to set a duration of a drying cycle and to control the fan, germicidal light, and heating element to operate for the set duration.

8. The apparatus of claim 1 further comprising at least one control circuit configured to permit an operator to selectively set at least a temperature and air flow pressure within the chamber.

9. The apparatus of claim 8 further comprising a temperature sensor and an air pressure sensor located within the chamber.

10. The apparatus of claim 1 further comprising a user interface that permits a user to selectively enable the fan, the germicidal light, and the heating element independently from each other.

11. A method of drying biological specimens comprising:
enclosing a biological specimen within a chamber;
heating the biological specimen in the chamber;
forcing air over the biological specimen in the chamber; and
illuminating the biological specimen with germicidal light in the chamber.

12. The method of claim 11 wherein the heating is performed by introducing light within the chamber.

13. The method of claim 11 wherein the germicidal light is produced by an ultraviolet light located within the chamber.

14. The method of claim 11 wherein forcing air over the biological specimen comprises forcing air at an air pressure of 20 pounds per square inch (psi) and 40 psi in the chamber

15. The method of claim 11 wherein the heating of the biological specimen comprises heating the chamber to an internal temperature of between 70 degrees Fahrenheit and 80 degrees Fahrenheit.

16. The method of claim 11 wherein the heating, illuminating, and forcing of air are performed simultaneously.

17. The method of claim 16 further comprising:
providing a user interface that permits an operator to set a duration of a drying cycle; and
providing control circuitry for controlling the fan, germicidal light, and heating element to operate for the set duration.

18. The method of claim 17 further comprising;
sensing a temperature within the chamber; and
sensing an air pressure within the chamber.
